(19) United States
(12) Patent Application Publication
(10) Pub. No.: US 2012/0236682 A1
(43) Pub. Date: Sep. 20, 2012

(54) DEVICE FOR MIXING THE ADDITIVE COMPONENTS OF A MIXTURE PRODUCT TO BE ADDED TO A BASE COMPONENT OR MAIN COMPONENT

(75) Inventors: Klaus Ehrlinger, Frondenberg (DE); Tobias Cherdron, Bad Kreuznach (DE)

(73) Assignee: KHS GmbH, Dortmund (DE)

(21) Appl. No.: 13/513,878

(22) PCT Filed: Dec. 7, 2010
(86) PCT No.: PCT/EP2010/007408

§ 371 Date: Jun. 5, 2012

(30) Foreign Application Priority Data
Feb. 16, 2010 (DE) 10 2010 008 165.5

(51) Int. Cl. B01F 15/04

(52) U.S. Cl. 366/162.1

(57) ABSTRACT

An apparatus for batched mixing of an additive component from individual components for mixture products containing the additive component and for temporarily storing the additive component, which is part of a mixer for forming the mixture products by mixing an additive component with a base component includes a single batch tank connected by at least a control valve and/or a proportioning valve to connections supplying the individual components for proportioned introduction of the individual components. The single batch tank is connected to a mixing and buffer tank arranged on a level below the single batch tank for temporary storage of the mixed additive component.

The invention relates to an apparatus according to the preamble of patent claim 1.

For the production of mixture products, in particular for the production of drinks or mixed drinks as well, for example soft drinks or lemonades, each out of one base component (for example water) and at least one for example flavouring and/or colouring and/or preserving additive component which is in its turn produced from a plurality of individual components by mixing, methods and mixing devices which are also referred to as mixers are known and which each comprise among other things a plant component, for example a tank for degassing the base component (water), one or a plurality of admixture devices and/or mixing sections for the metered admixture of the at least one additive component, a device for carbonating the mixture product consisting of the main component and the at least one additive component as well as a device for temporarily storing the mixture product.

The additive component, which in the case of drinks is also referred to as syrup, is usually premixed from the individual components in a separate premixing space (also syrup space) and then in the mixing device is blended with the degassed main component (water) or diluted with this main component to the final concentration.

Methods and devices for the pre-proportioning or premixing of the additive components in the separate premixing space (syrup space) are known in which the individual components are each proportioned into an associated batch tank under the control of flow meters or load cells. For this purpose, use is made of very large receiver tanks or two parallel batch tanks alternately. One of the disadvantages of this is that all arriving or departing pipes including fittings, mixing pump, mixing system must be provided twice or in even greater number. The batch tanks are usually designed with such large capacity that they contain a volume sufficient to achieve a continuous filling time of at least 15 minutes during which time the other batch tank provided in parallel is refilled. High investment costs arise as a consequence of these requirements and the resulting container volumes.

Other methods and mixing devices/mixers are also known which are configured for inline proportioning and in which, inside the mixer, each individual component is introduced proportioned parallel inline into the main component (water). The disadvantage with these methods is a considerable technical complexity since each individual component requires its own proportioning leg with among other things header vessel, level measurement, feed controller, pump, flow meters, volume control valve etc. A further disadvantage is that the pumps which run continuously and/or constantly during the proportioned addition of the individual components bring about an unwanted heating up of the individual components, in particular of those individual components which as small components are only present in the end product with a minimal mass fraction or quantity fraction. This heating up can lead to considerable product damage.

A further disadvantage of known methods for inline proportioning is that a protected, i.e. redundant, measurement of the added individual components that is often desired to ensure product quality, i.e. in particular also a check and/or examination of the measured data of flow meters (mass flow meters and/or volumetric flow meters) and/or weighers used for the proportioning as well as inline control measurement methods for detecting faulty measurements or proportionings are not possible or highly complex.

The task of the invention is to provide a device with which the investment volume for a complete plant for producing mixture products, in particular mixed drinks, is significantly reduced. A device according to patent claim 1 is configured to achieve this object.

It is a general particularity of the invention that the device for the mixing or production of the respective additive component from its individual constituents is an integral part of the mixing device/mixer in which this additive component is added to the base component or main component (for example water). This configuration alone achieves a considerable reduction in the investment volume of a complete plant by doing away with a separate premixing or syrup space and the devices therein.

The additive component, for example in the case of mixture products in the form of drinks, is for example a flavouring and/or colouring and/or preserving component.

A further particularity of the invention is that only a single batch tank is provided for the mixing of the additive component from the individual components and into which, during each proportioning cycle, all individual components required by the recipe are introduced in a proportioned manner and preferably at least partially in chronological order. At the end of each proportioning cycle the individual components or the additive component thereof composed are drained into the buffer tank through a liquid connection, preferably in free fall, so that an intensive blending of the individual components already takes place in the liquid connection.

In the sense of the invention therefore the phrase “batched mixing of the additive components” must be understood to mean that in every proportioning cycle preferably at least all of the individual components forming the respective additive component are proportioned into the batch tank and that this batch tank is then emptied into the mixing and buffer tank.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

The invention is explained in detail below through the use of an embodiment example with reference to the figures. In the figures:

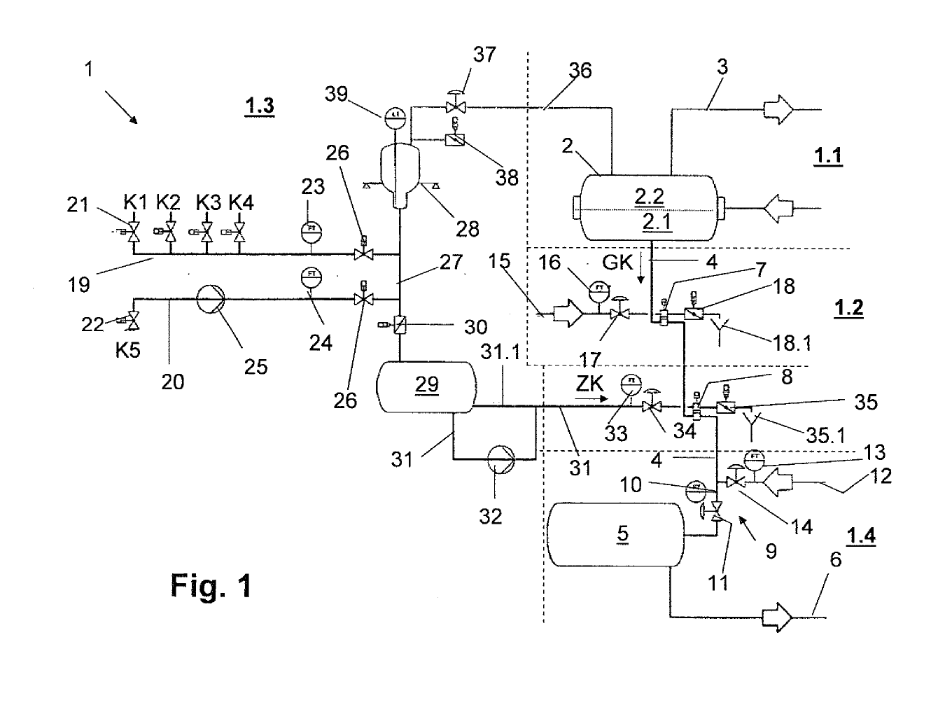

FIG. 1 shows in a simplified function diagram a mixing plant or mixing device (mixer) for the mixing or blending of a liquid base component (water) with a liquid additive component ZK (syrup) which is in turn produced for example by mixing from at least two individual components K1-K5;

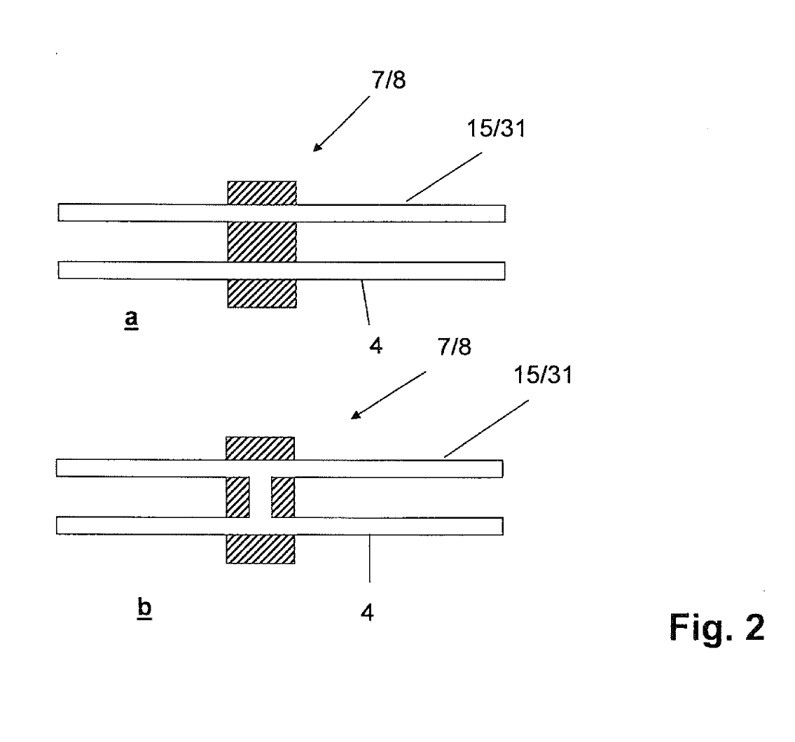

FIG. 2 shows in schematic functional representation a cross valve in the closed state (item a) and in the open state (item b).

The mixing device (mixer) generally designated by 1 in FIG. 1 serves to produce mixture products in the form of drinks by mixing a liquid base component GK, namely usually water, with an additive component ZK (blended syrup) which is in turn produced as a flavouring and/or colouring and/or preserving component by mixing from a plurality of individual components K1-K5, and to carbonate and buffer store the respective mixture product. Mixing device 1 can for this purpose be subdivided functionally into a plurality of device or plant sections 1.1-1.4, of which plant section 1.1 serves the preparation of base component GK or of the water by degassing and plant section 1.2 serves the proportioned admixing of the one or plurality of additive components ZK to base component GK and plant section 1.3 serves the provision of additive component ZK by mixing this component from individual components K1-K5 according to the particular predetermined recipe. Plant section 1.4 serves the carbonating and buffer storing of the mixture product.

Plant section 1.1 comprises essentially a tank 2 to which the water is fed in the required quantity during the operation of mixing device 1 in such a way that tank 2 is partly filled under level control with base component GK, thereby creating in tank 2 a lower liquid space 2.1 and lying above it a gas space 2.2. Gas space 2.2 is connected by a line 3 with a vacuum source (vacuum pump) for the degassing of base component GK. A line 4 which carries base component GK and subsequently the mixture product connects tank 2 to a buffer tank 5 which is connected by a product line 6 to a filling machine (not shown) for filling the mixture product or drink into bottles or other containers.

In the case of the depicted embodiment, there are provided in line 4 sequentially in the direction of flow from tank 2 to buffer tank 5 a connection valve 7 through which a concentrated aqueous sugar solution (for example a 70% sugar solution) can be introduced into base component GK to sweeten the mixture product, and a further connection valve 8 through which additive component ZK is introduced into base component GK.

In the direction of flow following connection valve 8, line 4 forms in a section of line upstream of buffer tank 5 a carbonating leg which is indicated in the figure by arrow 9 and in which are provided among other things a flow meter 10 and downstream of this a flow control valve 11 in line 4. In the direction of flow of the mixture product upstream of flow meter 10, a CO2 line 12 opens via at least one nozzle orifice, which (CO2 line) is connected to a CO2 source (not shown) providing a pressurised CO2 gas and in which are provided a flow meter for measuring the quantity of CO2 gas flowing through line 12 and a CO2 flow metering valve 14. Control electronics (not shown) controls—as a function for example of the measurement signals of flow meters 10 and 13—CO2 flow metering valve 14 such that the mixture product displays the required or specified CO2 content after inline carbonating or after carbonating leg 9.

For the proportioned addition of the sugar or sugar concentrate, a line 15 is provided on the open connection valve 7 and is connected to a source for providing the sugar concentrate and in which a flow meter 16, a sugar/large component flow metering valve 17, connection valve 7 as well as a shut-off or gully valve 18 are provided with which the other end of line 15 can be opened and closed in respect of a drain 18.1 and which is of course in the closed state during the admixing of the sugar to base component GK but which is opened for example for a purging or cleaning of line 15. The throughput design of plant section 1.3 is significantly reduced by the admixing of the liquid sugar through connection valve 7 directly into base component GK.

Alternatively however the liquid sugar can also be added in plant section 1.3, for example as individual component K5.

Plant section 1.3 in which the proportioned mixing of additive component ZK from individual components K1-K4 takes place comprises among other things two proportioning lines 19 and 20 of which proportioning line 19 exhibits a plurality of separate connections for individual components K1-K4 and each formed by a separate valve 21. Individual components K1-K4 are for example small components which are present in additive component ZK at best with a small mass fraction or quantity fraction and of which for individual component K1 can also be water, preferably degassed water from tank 2.

Proportioning line 20 exhibits a connection formed by valve 22 for feeding individual component K5 which is a large component, i.e. a component which is present in additive component ZK with the greatest mass fraction or quantity fraction. Flow meters 23 and 24 (mass and/or volumetric meters) are provided in proportioning lines 19 and 20 respectively. There is further provided in proportioning line 20 upstream—in the direction of flow—of flow meter 24 there located for example a proportioning and feed pump 25.

In the direction of flow of components K1-K5 and downstream respectively of flow meters 23 and 24, the two proportioning lines 19 and 20 are connected by valves 26 to a master line 27 which in turn connects a lower inlet and outlet of a header or batch tank 28 to a mixing and buffer tank 29 which is arranged beneath the latter tank and which holds additive component ZK. In master line 27 there is also provided a shut-off valve 30 between the connection of lines 20 and 27 and mixing and buffer tank 29.

To the outlet of mixing and buffer tank 29 is connected a line 31 carrying additive component ZK and in which are disposed, starting from mixing and buffer tank 29, a proportioning or circulation pump 32, a flow meter 33 (mass flow meter and/or volumetric flow meter), a concentrate flow metering valve 34, connection valve 8 and a shut-off or gully valve 35 with which the end of line 31 that is away from mixing and buffer tank 29 can be closed or can be opened towards a drain 35.1.

The rated flow of proportioning or circulating pump 32 is set so that the volumetric flow generated by this pump is greater than the maximum amount of additive component ZK that is to be admixed to base component GK. The partial quantity of additive component ZK that is not required is returned to mixing and buffer tank 29 through a line 31.1. The admixing of additive component ZK to base component GK is effected when connection valve 8 is open through concentrate flow metering valve 34 being triggered by the control electronics as a function of the signals from flow meter 33 and a further flow meter provided in line 4, for example flow meter 10.

The particularity of mixing device 1 consists in the plant components used for mixing additive component ZK and in the special controlling of the mixing process. This latter is effected in that, in the respective proportioning cycle, the individual components K1-K5 are proportioned in chronological order or are introduced into batch tank 28 in the quantities and/or fractions according to the particular recipe as a function of the measurement signals of flow meters 23 and 24, with at least one of components K1-K4 being aspirated by vacuum for gentle treatment. For this purpose batch tank 28 is connected by a vacuum line 36 which exhibits a vacuum regulating valve 37 to gas space 2.2 of tank 2, this having among other things the advantage that an additional vacuum source is not needed and in particular that aroma losses or losses of individual components are avoided because these are washed out again in tank 2 and so are ultimately fed onto the mixture product.

If a separation of the individual components in lines 19 and 27 is desired or necessary during the proportioning cycle, then for example one of individual components K1-K4 is water so that by briefly opening the associated valve 21 of that component a separating “water plug” can be passed through lines 19 and 27 into batch tank 28.

The proportioned introduction of component K5 into batch tank 28 is effected with pump 25 with the possible assistance of vacuum. It is however possible in principle to dispense with pump 25 and to introduce individual component K5 in a proportioned manner into batch tank 28 by suction as well.

The use of a dedicated proportioning line 20 for the larger individual component K5 has the advantage that among other things the smaller individual components K1-K4 can be proportioned with greater accuracy through an appropriate configuration of flow meters 23 and 24. The use of proportioning line 20 also allows the proportioning of individual component K5 to be carried out chronologically in parallel with the proportioning of individual components K1-K4.

At the end of the respective proportioning cycle, i.e. after the introduction into batch tank 28 of all individual components K1-K5 that are required by the recipe, the content of this tank is emptied into mixing and buffer tank 29 by closing valve 26 and opening valve 30. The arrangement is preferably selected such that after valve 30 is opened, the content of batch tank 28 can flow through master line 27 in free fall or flow, with a blending of the individual components already taking place in the process. Accordingly, master line 27 is designed with a suitably large cross-section. During this emptying, batch tank 28 is brought up to ambient pressure by opening a vent valve 38. It is also possible to pressurise batch tank 28 in order to accelerate emptying.

It is particularly advantageous to equip batch tank 28 with means that allow a redundancy measurement and/or redundant check of the proportioning of the individual components and in particular also of the smaller individual components K1-K4. For this purpose a further flow meter and/or a level meter 39 is provided for example at the inlet/outlet of batch tank 28 and/or batch tank 28 is equipped with a weigher with which the quantities of individual components K1-K5 introduced into batch tank 28 can then also be determined for a redundancy measurement. Measuring the height of the liquid level in batch tank 28 is also possible. In this case the measurement accuracy can be enhanced by configuring individual sectors of batch tank 28 with different diameters, as shown in the figure. The redundancy measurement can be carried out in all cycles for all individual components K1-K5. To save time however this can also be done at intervals, for example per batch or cycle and only for the individual component introduced first, with the chronological order of the introduction of the individual components into batch tank 28 being selected randomly or alternately by turns.

Batch tank 28 has a reduced volume so that for the respective proportioning cycle comprising proportioning phase and the emptying of batch tank 28 into mixing and buffer tank 29 very short cycle times can be achieved, for example cycle times of under five minutes.

The interior of mixing and buffer tank 29 is preferably so designed, for example divided up by partitions, that it possesses a rudimentary “first-in/first-out characteristic” and that in this tank the blending of the individual components is further enhanced by the return feeding of the partial stream through line 31.1, so that with suitable products, mechanically actuated mixing and/or agitating elements are not required for the complete mixing of additive component ZK.

Connection valves 7 and 8 are preferably constructed as cross valves having the configuration which is schematically depicted in FIG. 2 and with which when in the open state (FIG. 2 b) the connection between line 16/31 and line 4 exists. When respective connection valve 7 or 8 is in the closed state (FIG. 2a), not only is this connection blocked but it is also possible to purge line 16 or 31 after the opening of gully valve 18 or 35 respectively, for example during a working cycle of mixing device 1 when the connection is not needed.

At the end of the filling of a certain product or certain product batch, while mixing and buffer tank 29 is being emptied, additive component ZK can already be prepared in batch tank 28 for the next product batch according to the new recipe and can then be drained off into mixing and buffer tank 29 after the latter has been completely emptied or run empty.

The described mixing device can be used to produce mixture products to the respectively required recipe from base component GK and from at least one so individual component K1-K5, with all individual components K1-K5 standing ready at the corresponding connections of proportioning lines 19 and 20 but with the controlled opening of valves 21 and 22 only introducing those individual components K1-K5 into batch tank 28 which are actually needed for the current recipe.

The invention has been described hereinbefore by reference to one embodiment. It goes without saying that numerous variations and modifications are possible without departing from the inventive concept underlying the invention.

### LIST OF REFERENCE SIGNS

1 Mixing device

1.1-1.4 Plant section

2 Tank

2.1 Liquid space

2.2 Gas space

3,4 Line

5 Buffer tank for mixed product

6 Product line

7, 8 Connection valve, for example cross valve

9 Carbonating leg

10 Flow meter

11 Flow control valve

12 CO2 line

13 Flow meter

14 CO2 flow metering valve

15 Line

16 Flow meter

17 Flow metering valve for sugar/main component

18 Gully valve

18.1 Drain

19,20 Line

21,22 Valve

23,24 Flow meters

25 Pump

26 Valve

27 Line

28 Collecting or batch tank

29 Mixing and buffer tank

30 Valve

31,31.1 Line

32 Proportioning or circulating pump

33 Flow meter

34 Concentrate flow metering valve

35 Gully valve

35.1 Drain

36 Vacuum line

37 Vacuum regulating valve

38 Vent valve

39 Flow meter/level meter

K1-K5 Individual component

ZK Mixed additive component

GK Base or main component

1-10. (canceled)

11. An apparatus for batched mixing of an additive component from individual components to form mixture products containing said additive component and to temporarily store said additive component, said apparatus being part of a mixer for forming said mixture products by mixing an additive component with at least one base component, said apparatus comprising a single batch tank connected by at least one of a control valve and a proportioning valve to connections supplying said individual components for proportioned introduction of said individual components, said single batch tank being connected to a mixing and buffer tank for temporary storage of said mixed additive component, said mixing and buffer tank being arranged on a level below said single batch tank.

12. The apparatus of claim 11, said apparatus being configured for feeding said individual components into said single batch tank by negative pressure.

13. The apparatus of claim 11, said apparatus being configured for vacuum-assisted feeding of said individual components into said single batch tank.

14. The apparatus of claim 11, further comprising a common proportioning line and a plurality of connections, each having a valve connected to said common proportioning line, for providing a corresponding plurality of individual components, said apparatus being configured for time-delayed proportioned introduction of said individual components into said single batch tank during a proportioning cycle.

15. The apparatus of claim 11, further comprising a dedicated proportioning line associated with an associated individual component, said associated individual component being an individual component that, compared with other individual components, constitutes the greater fraction in the mixed additive component.

16. The apparatus of claim 11, further comprising a circuit for said additive component, said circuit comprising said mixing and buffer tank and one of a proportioning pump and circulating pump, said one of a proportioning pump and circulating pump being configured for delivering said additive component to one of a mixing section and a mixing position for admixing of said additive component to said base component.

17. The apparatus of claim 11, wherein an inlet and outlet of said single batch tank are connected by a controlled liquid connection to said mixing and buffer tank, wherein proportioned feeding of said individual components into said single batch tank takes place during a respective proportioning cycle, and wherein draining of said individual components from said single batch tank takes place over said controlled liquid connection following completion of said respective proportioning cycle.

18. The apparatus of claim 11, further comprising means for at least one of capturing and measuring of a particular quantity of each individual component introduced during a proportioning cycle into said single batch tank, said means for at least one of capturing and measuring comprising a measuring device arranged in at least one proportioning line.

19. The apparatus of claim 18, wherein said measuring device comprises a flow meter.

20. The apparatus of claim 11, wherein said single batch tank comprises an independent measuring device for at least one of capturing and measuring a quantity of at least one individual component introduced into said single batch tank during a respective proportioning cycle.

21. The apparatus of claim 11, further comprising a vacuum for feeding individual components into said single batch tank, said vacuum comprising a function element of said mixer that is used for degassing of the base component, and wherein an interior of said single batch tank is connected by a controlled connection to an interior of said function element used for degassing.

22. The apparatus of claim 11, wherein said mixing and buffer tank is connected, via a connection valve configured as a cross valve, to one of said mixing position and said mixing section for admixing into said base component.
